(19) United States
(12) Patent Application Publication
(10) Pub. No.: US 2013/0275297 A1
(43) Pub. Date: Oct. 17, 2013

(54) REAL ESTATE SETTLEMENT USING DEDICATED DEPOSIT ACCOUNTS

(71) Applicant: EDEPOSIT CORPORATION, Rockville, MD (US)

(72) Inventor: Norman Understein, Potomac, MD (US)

(73) Assignee: eDeposit Corporation, Rockville, MD (US)

(21) Appl. No.: 13/860,821

(22) Filed: Apr. 11, 2013

Related U.S. Application Data
(60) Provisional application No. 61/623,753, filed on Apr. 13, 2012.

(51) Int. Cl. G06Q 20/38; G06Q 50/16

(52) U.S. Cl. CPC G06Q 20/38; G06Q 50/16
USPC 705/39

(57) ABSTRACT

Real estate settlements can be facilitated using dedicated deposit accounts so that last-minute adjustments can be avoided, and funds in the transaction can be readily transferred. A settlement manager provides estimates for funds required from at least one of a buyer and a seller based on terms of the real estate settlement and communicates hold requests. Funds are held based on the estimates provided by the settlement manager, where held funds remain in the respective deposit accounts but are otherwise unavailable. The settlement manager determines final settlement amounts, and the settlement manager initiates a transaction to transfer the final settlement amounts according to parameters of the real estate settlement. Subsequently, the computer system releases any remaining held funds in the respective deposit accounts.

### CROSS-REFERENCES TO RELATED APPLICATIONS

This application claims the benefit of U.S. Provisional Patent Application No. 61/623,753, filed Apr. 13, 2012, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The invention relates to systems and methods for processing a real estate settlement using dedicated deposit accounts.

The Real Estate Settlement process presents an opportunity for eDeposit to provide a solution for Settlement/Title companies (“STCs”) in a real estate transaction, and offers a way to engage banks, broker/agents, buyers and sellers, and other providers of services to the eDeposit system. STCs can include any party to a real estate transaction including settlement attorneys, escrow agents, realtors, title companies, etc.

The STCs are the central hub for closing a real estate transaction. They must be assured that funds from various parties are available, and that the funds are distributed to many parties (lenders, service providers, real estate agents/brokers, attorneys, utilities, taxing authorities, etc). The biggest problem with the existing settlement process is that in many cases, the exact amount of the final settlement transaction is not known until the last minute. Even after the settlement, there could be adjustments, and the funds need to be present to provide for the transaction.

A common feature that is standard in the real estate settlement industry is the Settlement Statement—currently known as the HUD-1. The HUD-1 is completed by the Settlement/Title company, and it is their responsibility to see that the HUD-1 is distributed to the parties, and that the funds are distributed as provided in the HUD-1.

Concerns for the settlement agent in a real estate transaction may include delayed lender's funds, thereby holding up the settlements, or borrower's funds received prior to settlement in incorrect amounts. Circumstances may also occur during settlement where the HUD-1 is corrected, resulting in adjustments to party payments. Additionally, funds that are wired to the settlement company may be improperly addressed, resulting in further delay until the funds are located. An average of seven checks and wire transfers are often required for each settlement.

Other problems arise with regard to Federal regulator concerns, including escrow agent misappropriation of funds, funds diverted from an escrow account as a result of fraud or identify theft, and the like.

### BRIEF SUMMARY OF THE INVENTION

It would be desirable if the funds from each party needed to provide them were “on hold” with a dedicated but personal account such as that available from eDeposit (www.eDeposit.com), and that each recipient of funds opened a registered account to receive the funds. Funds “on hold” exist in the party's account but are not otherwise available to the party, providing assurance that the funds will be available if/when needed. The STC could make last minute adjustments to the HUD-1, and at settlement complete the transaction, immediately disbursing the funds to the proper party—subject to the necessary terms provided by the parties. Additionally, it would be desirable if information relative to the transfer of funds included a description, invoice, receipt, or other identifying document(s).

In an exemplary embodiment, a method for processing a real estate settlement includes the steps of (a) a settlement manager providing estimates for funds required from at least one of a buyer and a seller based on terms of the real estate settlement; (b) the settlement manager communicating hold requests to the at least one of the buyer and the seller, wherein the buyer and the seller have access to respective deposit accounts; (c) the computer system enabling the at least one of the buyer and the seller to hold funds in the respective deposit accounts based on the estimates provided by the settlement manager, wherein held funds remain in the respective deposit accounts but are otherwise unavailable to the buyer and the seller; (d) the settlement manager determining final settlement amounts for the at least one of the buyer and the seller, and the settlement manager initiating a transaction to transfer the final settlement amounts according to parameters of the real estate settlement; and (e) after step (d), the computer system releasing any remaining held funds in the respective deposit accounts.

Step (b) may be practiced using the communication network interface. Step (c) may be practiced by the computer system enabling the at least one of the buyer and the seller to accept the hold requests communicated by the settlement manager. Step (c) may be further practiced such that by accepting the hold requests, the at least one of the buyer and the seller are holding the funds on behalf of the settlement manager.

Step (c) may be practiced by holding funds in amounts that exceed the estimates by a predetermined amount. In this context, step (c) may be practiced such that the predetermined amount is a percentage of an expected amount.

In one arrangement, step (c) may be practiced by determining whether the at least one of the buyer and the seller have registered deposit accounts, and if not, the computer system enabling the at least one of the buyer and the seller to establish the registered deposit accounts. Step (c) may be further practiced by linking the registered deposit accounts with respective existing accounts.

The method may further include a step of enabling the settlement manager to send a completed settlement document to the buyer and the seller (or other parties to the transaction) using the communication network interface.

Step (d) may be practiced in real time.

In another exemplary embodiment, a computer system includes at least one computer storage medium storing data and instructions, a communication interface, and at least one computer processor accessing the stored data and instructions and executing the instructions. The processor is programmed to perform the steps of the method.

In yet another exemplary embodiment, a computer system for processing a real estate settlement includes at least one user computer running a computer program that processes a hold request to at least one of a buyer and a seller according to estimates for funds required in the real estate settlement. A system server runs a server program, and the at least one user computer and the system server are interconnected by a computer network. The system server enables the at least one of the buyer and the seller to hold funds in respective deposit accounts based on the estimates, where held funds remain in the respective deposit accounts but are otherwise unavailable to the buyer and the seller. The system server enables entry of final settlement amounts, and the at least one user computer initiates a transaction to transfer the final settlement amounts according to parameters of the real estate settlement. The system server releases any remaining held funds in the respective deposit accounts.

In still another exemplary embodiment, a computer program embodied on a computer-readable medium for processing a real estate settlement includes means for carrying out the settlement processing method.

### BRIEF DESCRIPTION OF THE DRAWINGS

These and other aspects and advantages will be described in detail with reference to the accompanying drawings, in which:

FIG. 1 is a flow diagram illustrating the settlement process according to preferred embodiments of the invention; and

FIG. 2 is a detailed schematic illustration of a computer system.

### DETAILED DESCRIPTION OF THE INVENTION

With the system and methodology of the preferred embodiments, real estate settlements can be closed by an STC without a traditional “escrow account.” Funds needed by the borrower, lender, or others (the “Transmitting Party”) are placed on hold in the Transmitting Party's own bank account, and can not be reversed unless released by the designated Settlement Agent. The Settlement Agent can see that the funds are there and ready to be used only for the settlement. The Settlement Agent finalizes the HUD-1, and when all of the terms of the lender and other parties have been met, funds are immediately sent, in real time, to pay loans, title companies, real estate agents, utilities, etc (the “Receiving Party”). Each Receiving Party receives the necessary supporting documents when the funds are sent—all movement of funds are sent and received as reflected in the HUD-1, in real time. If certain payments need to be delayed for regulatory purposes, that can be provided for in the system. If a Transmitting Party placed too much on hold, any funds not needed can be immediately released back to the Transmitting Party.

For the “real time” movement of funds, the Transmitting Party (person sending funds) places funds into either their existing registered account (such as an existing eDeposit Account, or a new eDeposit Account). The funds are placed on hold for a Receiving Party (in the case oft he Real Estate Settlement Process, the STC administers when the transfer would take place, and what is transferred). When the STC designates that the transfer take place, the funds are immediately taken out of the Transmitting Party's Account, and the system simultaneously places the funds into the Receiving Party's Account (if the Receiving Party has not opened a registered account, the funds can be placed into a registered account for the benefit of the Receiving Party, until such time as the Receiving Party has opened the account).

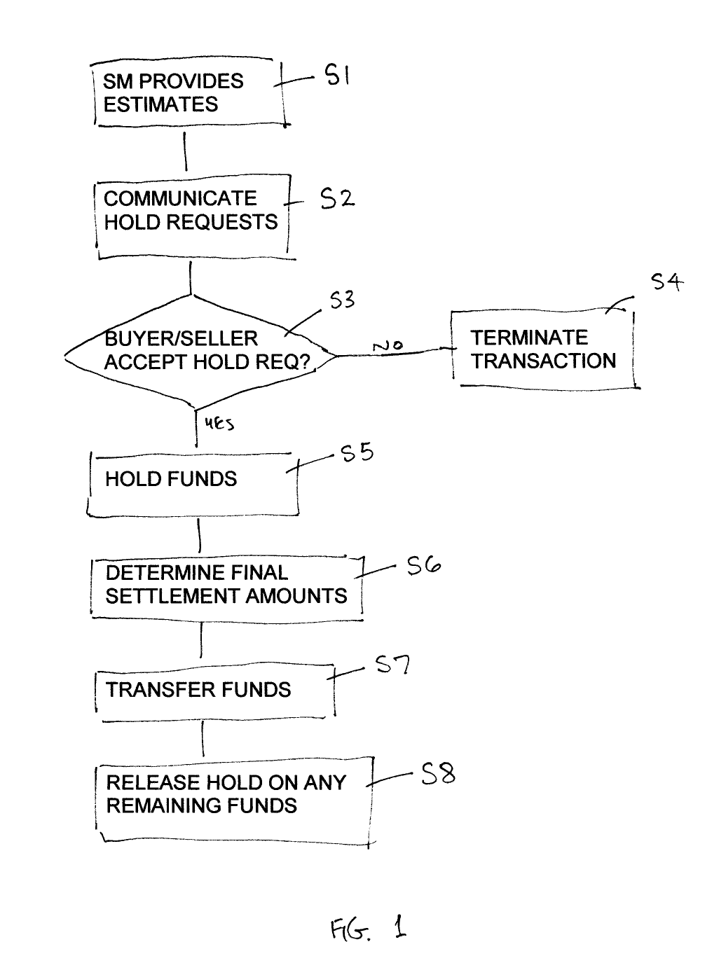

FIG. 1 is a flow diagram of the real estate settlement methodology. Prior to the transaction, participants requiring funds available for settlement can open a registered deposit account (e.g., an eDeposit account). Participants who only “receive” funds—e.g., real estate brokers receiving commissions, and the like—do not need to open an account, but may do so any time prior to the closing, or may receive their payments/commissions through the current process (via a check, wire transfer, etc). Subsequently, each participant establishes a funding source (i.e., links their account to a bank account, provides cash, cashier's check, etc.).

In step S1, a settlement manager provides estimates for funds required from at least one of a buyer and a seller based on terms of the real estate settlement. Funds may be due from the seller based on certain fees or a mortgage status of the property being sold, etc. The settlement manager communicates hold requests to the buyer and/or seller via e-mail or the like or through an account administrator corresponding to respective buyer and seller deposit accounts (step S2). The settlement manager may also send a draft or preliminary HUD-1 form. In this context, the account administrator may first determine whether the buyer and/or seller have registered deposit accounts. If not, the system enables the buyer and/or seller to establish a registered deposit account or otherwise may terminate the transaction.

The system enables the buyer and/or seller to hold funds in respective deposit accounts based on the estimates provided by the settlement manager. If there are insufficient funds in the buyer's and/or seller's account, the buyer and/or seller are provided an opportunity to fund their account. Held funds remain in the respective deposit accounts but are otherwise unavailable to the buyer and the seller. In step S3, the system queries whether the buyer and/or seller have accepted the hold request, and if not (NO in step S3), the transaction is terminated (step S4). If the hold requests are accepted (YES in step S3), the funds are held. Held amounts show as deposits/balances in the participants' accounts but are not available, as holds on behalf of the settlement manager.

During settlement, the settlement manager determines final settlement amounts for the buyer and/or seller. The STC could make last minute adjustments to the HUD-1, and at settlement complete the transaction, immediately dispersing the funds to the proper parties, subject to the necessary terms provided by the parties and according to parameters of the real estate settlement (steps S6 and S7). Subsequently, the system releases any remaining held funds in the respective deposit accounts (step S8). Participants that were not required to fund accounts or hold money on behalf of the settlement will receive payments due them via the administrator account network as initiated by the settlement manager, including taxes, municipal utilities, loan payoffs, seller proceeds, agent commissions, etc. The participants may be sent a communication alerting them to the available funds and providing a link to the system so that they can open an account to receive the funds. These participants could alternatively elect to receive the funds via a check or other payment method.

By accepting the hold requests, the buyer and/or seller are holding the funds on behalf of the settlement manager. In one embodiment, the funds are held in amounts that exceed the estimates by a predetermined amount, such as a percentage of an expected amount due from settlement. In this manner, if an adjustment is required during the settlement process wherein additional funds may be needed from the buyer and/or seller, the funds will already be available.

The system can provide/establish for each of the parties to the transaction a web based page reflecting the status of the transaction. The STC would have an application programming interface (API) to the eDeposit website, to facilitate integrating their own current system to the standard HUD-1. The STC's Administrative Page would allow them to drive the transaction. An API is a protocol intended to be used as an interface by software components to communicate with each other. An API is a library that may include specification for routines, data structures, object classes, and variables. An API specification can take many forms, including an International Standard such as POSIX, vendor documentation such as the Microsoft Windows API, the libraries of a programming language, e.g. Standard Template Library in C++ or Java API.

The HUD-1 would reflect the administration fee (suggested as $25.00) which could be split and paid by either or both Buyer and Seller. When considering the total fees paid by the parties, this fee should be insignificant. Additionally, there is a significant savings over wire transfer fees and courier-type charges from the various parties that are often passed along to the Buyer and Seller.

While it would be ideal for the STC to require the parties to use the present system, they could also simply request that they use the system, and point out the benefits, but only disburse funds to certain parties through the system.

As the real estate settlement process involves myriad participants, there are a variety of ways transactions can be settled through system. For the funds to flow effectively and settle in real time, participants will have a registered deposit account (e.g., an eDeposit account). The service does contemplate disbursements to non-account holders, too. Those disbursements are initiated from the administrator's clients' or partners' system accounts.

Parties to a Typical Real Estate Settlement:

Seller Side:

Seller (Immediate receipt of funds upon settlement)

Seller Real Estate Agent/Broker (Immediate receipt of funds upon settlement)

Seller's Lender—who will be paid for any loan balance (Immediate receipt of funds upon Settlement).

Buyer Side:

Buyer (Required Party—must reflect funds needed to settle)

Buyer Real Estate Agent/Broker (Immediate receipt of funds upon settlement)

Buyer's lender—who is lending money for the transaction. (Funds remain at bank until closing). Typically, funds are sent to the Settlement/Title company by a certified check or wire transfer along with the Terms of Settlement. Now the Terms of Settlement can be sent via PDF to the STC, and when they “accept” the Terms of Settlement, the funds are placed on hold. Also, typically the Lender may require a check to be endorsed by all receiving parties. Using the described system, the STC will require the borrowers to sign an endorsement at settlement, to be sent to the Lender.

Settlement/Title Company (STC) Side:

The STC is the biggest beneficiary, since they will not need to issue checks to the many providers of services (see below), will be able to make adjustments at the last minute and still know the funds are available from all of the parties. The API to the system would be one that integrates with their own system, or could be incorporated into settlement software provided by others, since they almost always use the HUD-1 as the overriding document in the settlement transaction.

Many of the parties receiving funds could be sent an email from the administrator, stating funds are being sent for the XYZ Settlement, and direct them to log onto the system to open an account. Once they open an account, they can opt to keep the account as their source of funds, or link it to an existing DDA (direct deposit account) to have the funds ACH transferred to that account.

Payments and Service Providers:

Real Estate Tax payments

Home Owner's Insurance Company payments

Many Service Providers

Government Recording Charges

Title Insurance

Benefits of the system and methodology include, for example, (1) funds are transmitted in real time; (2) no escrow accounts or related potential of fraud or misuse; (3) possible elimination on requirements related to Interest On Lawyers Trust Accounts (“IOLTA”), and any other escrow account regulations and paperwork; (4) lenders keep their funds at their own bank until the settlement takes place—funds are never needed to be sent back to the lender if the settlement does not take place or is delayed; (5) no need for the Settlement Agent to draft checks to receiving parties, and no wire transfer or shipping expenses for documents; and (6) costs a fraction of the cost of writing checks, wire transfers, and document transfers—for an average settlement of seven money and document transfers, the total expense could be less than $10.00.

The real estate settlement system described above is preferably a browser-based system in which a program running on a user's computer (the user's web browser) requests information from a server program running on a system server. The program may be accessible via a hand-held device such as a smart phone or tablet and may be embodied in a software app. In an exemplary configuration, the system server sends the requested data back to the browser program and the browser program then interprets and displays the data on the user's computer screen. The process is as follows:
1. The user runs a web browser program on his/her computer.
2. The user connects to the server computer (e.g., via the Internet). Connection to the server computer may be conditioned upon the correct entry of a password as is well known.
3. The user requests a page from the server computer. The user's browser sends a message to the server computer that includes the following:
   the transfer protocol (e.g., http://); and
   the address, or Uniform Resource Locator (URL).
4. The server computer receives the user's request and retrieves the requested page, which is composed, for example, in HTML (Hypertext Markup Language).
5. The server then transmits the requested page to the user's computer.
6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java™ enable the browser, among other things, to play sound and/or display video inserted in the HTML file. The fonts installed on the user's computer and the display preferences in the browser used by the user determine how the text is formatted.

If the user has requested an action that requires running a program (e.g., a search), the server loads and runs the program. This process usually creates a custom HTML page “on the fly” that contains the results of the program's action (e.g., the search results), and then sends those results back to the browser.

Browser programs suitable for use in connection with the real estate settlement system of the present invention include Firefox® available from Mozilla® and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the system server could be provided.

It will be recognized by those in the art that various tools are readily available to create web pages for accessing data stored on a server and that such tools may be used to develop and implement the real estate settlement system described above and illustrated in the accompanying drawings.

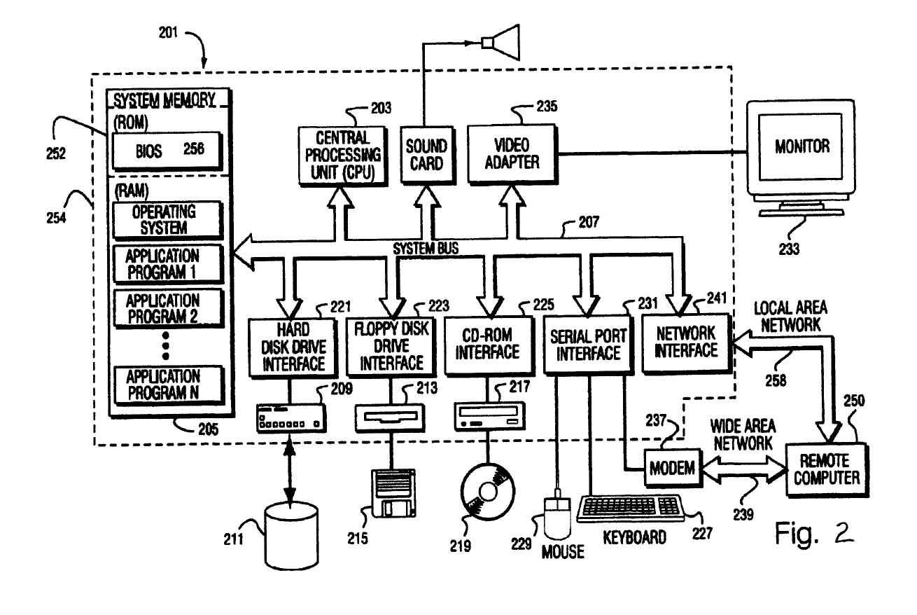

FIG. 2 generally illustrates a computer system 201 suitable for use as the client and server components of the real estate settlement system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem 237 or other means for establishing communications over the wide area network 239, such as the Internet. The modem 237, which may be internal or external, is connected to the system bus 207 via the serial port interface 231. A network interface 241 may also be provided for allowing the computer system 201 to communicate with a remote computing device 250 via a local area network 258 (or such communication may be via the wide area network 239 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method for processing a real estate settlement using a computer system including a processor programmed to carry out steps of the method and a communication network interface, the method comprising:
(a) a settlement manager providing estimates for funds required from at least one of a buyer and a seller based on terms of the real estate settlement;
(b) the settlement manager communicating hold requests to the at least one of the buyer and the seller, wherein the buyer and the seller have access to respective deposit accounts;
(c) the computer system enabling the at least one of the buyer and the seller to hold funds in the respective deposit accounts based on the estimates provided by the settlement manager, wherein held funds remain in the respective deposit accounts but are otherwise unavailable to the buyer and the seller;
(d) the settlement manager determining final settlement amounts for the at least one of the buyer and the seller, and the settlement manager initiating a transaction to transfer the final settlement amounts according to parameters of the real estate settlement; and
(e) after step (d), the computer system releasing any remaining held funds in the respective deposit accounts.

2. A method according to claim 1, wherein step (b) is practiced using the communication network interface.

3. A method according to claim 2, wherein step (c) is practiced by the computer system enabling the at least one of the buyer and the seller to accept the hold requests communicated by the settlement manager.

4. A method according to claim 3, wherein step (c) is further practiced such that by accepting the hold requests, the at least one of the buyer and the seller are holding the funds on behalf of the settlement manager.

5. A method according to claim 1, wherein step (c) is practiced by holding funds in amounts that exceed the estimates by a predetermined amount.

6. A method according to claim 5, wherein the step (c) is practiced such that the predetermined amount is a percentage of an expected amount.

7. A method according to claim 1, wherein step (c) is practiced by determining whether the at least one of the buyer and the seller have registered deposit accounts, and if not, the computer system enabling the at least one of the buyer and the seller to establish the registered deposit accounts.

8. A method according to claim 7, wherein step (c) is further practiced by linking the registered deposit accounts with respective existing accounts.

9. A method according to claim 1, further comprising enabling the settlement manager to send a completed settlement document to the buyer and the seller using the communication network interface.

10. A method according to claim 1, wherein step (d) is practiced in real time.

11. A computer system including at least one computer storage medium storing data and instructions, a communication interface, and at least one computer processor accessing the stored data and instructions and executing the instructions to perform steps including:
(a) enabling a settlement manager to provide estimates for funds required from at least one of a buyer and a seller based on terms of the real estate settlement;
(b) communicating hold requests to the at least one of the buyer and the seller, wherein the buyer and the seller have access to respective deposit accounts;
(c) enabling the at least one of the buyer and the seller to hold funds in the respective deposit accounts based on the estimates provided by the settlement manager, wherein held funds remain in the respective deposit accounts but are otherwise unavailable to the buyer and the seller;
(d) the settlement manager determining final settlement amounts for the at least one of the buyer and the seller, and the computer system enabling settlement manager to initiate a transaction to transfer the final settlement amounts according to parameters of the real estate settlement; and
(e) after step (d), releasing any remaining held funds in the respective deposit accounts.

12. A computer system according to claim 11, wherein step (b) is practiced using the communication interface.

13. A computer system according to claim 12, wherein step (c) is practiced by the computer system enabling the at least one of the buyer and the seller to accept the hold requests communicated by the settlement manager.

14. A computer system according to claim 13, wherein step (c) is further practiced such that by accepting the hold requests, the at least one of the buyer and the seller are holding the funds on behalf of the settlement manager.

15. A computer system according to claim 11, wherein step (c) is practiced by holding funds in amounts that exceed the estimates by a predetermined amount.

16. A computer system according to claim 15, wherein the step (c) is practiced such that the predetermined amount is a percentage of an expected amount.

17. A computer system according to claim 11, wherein step (d) is practiced in real time.

18. A computer system for processing a real estate settlement, the computer system comprising:
at least one user computer running a computer program that processes a hold request to at least one of a buyer and a seller according to estimates for funds required in the real estate settlement; and
a system server running a server program, the at least one user computer and the system server being interconnected by a computer network, the system server enabling the at least one of the buyer and the seller to hold funds in respective deposit accounts based on the estimates, wherein held funds remain in the respective deposit accounts but are otherwise unavailable to the buyer and the seller,
wherein the system server enables entry of final settlement amounts, and wherein the at least one user computer initiates a transaction to transfer the final settlement amounts according to parameters of the real estate settlement, the system server releasing any remaining held funds in the respective deposit accounts.

19. A computer program embodied on a computer-readable medium for processing a real estate settlement, the computer program comprising:
means for providing estimates for funds required from at least one of a buyer and a seller based on terms of the real estate settlement;
means for communicating hold requests to the at least one of the buyer and the seller, wherein the buyer and the seller have access to respective deposit accounts;
means for enabling the at least one of the buyer and the seller to hold funds in the respective deposit accounts based on the estimates provided by the settlement manager, wherein held funds remain in the respective deposit accounts but are otherwise unavailable to the buyer and the seller;
means for entering final settlement amounts for the at least one of the buyer and the seller, and means for initiating a transaction to transfer the final settlement amounts according to parameters of the real estate settlement; and
means for, after entering the final settlement amounts, releasing any remaining held funds in the respective deposit accounts.

20. A computer program according to claim 19, wherein the means for initiating the transaction comprises means for initiating in real time.
